(19) United States
(12) Patent Application Publication
(10) Pub. No.: US 2008/0145186 A1
(43) Pub. Date: Jun. 19, 2008

(54) Fastening device

(76) Inventor: Zuofeng Jin, Keelung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/896,136

(22) Filed: Aug. 30, 2007

(30) Foreign Application Priority Data
Dec. 15, 2006 (CN) 200620154817.5

(51) Int. Cl. F16B 15/02

(52) U.S. Cl. 411/480

(57) ABSTRACT

A fastening device is used for fastening a fastened object on a circuit board. The fastening device includes a fastening part for fastening the fastened object. The fastening part includes a main body portion. The main body portion extends to form a wedging portion. An end of the wedging portion extends to form a buckling portion. The fastening device also includes a tightly-locking part that fits with the fastening part. One end of the tightly-locking part passes through the main body portion of the fastening part and is positioned on the positioning hole of the circuit board. The second end of the tightly-locking part fits with the buckling portion to tightly lock the fastened object. The fastening device of the present invention merely includes the fastening part and the tightly-locking part. Its structure is simple, and the required space is small.

### BACKGROUND OF THE INVENTION

1. Field of the Invention

The present invention relates to a fastening device.

2. Description of the Related Art

As the technology has been highly developed, a variety of equipments and electronic devices become slim and small to meet the customer's requirements. Even though the functions and components are added to the electronic devices, the electronic devices still has a low height and a small dimension, especially for a portable electronic device.

Interface cards are the communication bridges between the motherboard and the peripherals. With the portable electronic devices become slim more and more, the miniaturization of the interface cards is also needed.

At present, the interface card with a Mini PCI format that is popularly applied to the laptop has a traverse-plugging design. The positioning hole for connecting the interface card with the electrical connector on the motherboard is traverse. After the interface card is connected with the electrical connector, the interface card horizontally positions on the motherboard to reduce the required height.

In order to increase the fastening force of the electrical connector, a fastening device is added to the motherboard to prevent the interface card from escaping from the electrical connector due to an external force as disclosed in the China patent 200520105014.6. But the shortcoming of the fastening device is its structure is complex and it is difficult for the user to operate it.

### SUMMARY OF THE INVENTION

One particular aspect of the present invention is to provide a fastening device. Its structure is simple. The required space is small. It can firmly fasten the fastened object. It is easy for the user to operate it.

The fastening device is used for fastening a fastened object on a circuit board. The fastening device includes a fastening part for fastening the fastened object. The fastening part includes a main body portion. The main body portion extends to form a wedging portion. An end of the wedging portion extends to form a buckling portion. The fastening device also includes a tightly-locking part that fit with the fastening part. One end of the tightly-locking part passes through the main body portion of the fastening part and is positioned on the positioning hole of the circuit board. The second end of the tightly-locking part fits with the buckling portion to tightly lock the fastened object.

The fastening device of the present invention merely includes the fastening part and the tightly-locking part. Its structure is simple, and the required space is small. When the user uses the fastening device, the user merely needs to pass one end of the tightly-locking part through the main body portion of the fastening part and positions it onto the positioning hole of the circuit board, and make the second end of the tightly-locking part to fit with the buckling portion and tightly lock the fastened object. The procedure is simple. Because the fastening part cooperates with the tightly-locking part, the fastening device firmly fastens the fastened object, such as an electronic card.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is a perspective view of the fastening device of the present invention;

FIG. 2 is another perspective view of the fastening device of the present invention;

FIG. 3 is an exploded perspective view of the fastening device of the present invention;

FIG. 4 is a perspective view of the fastening part of the fastening device of the present invention;

FIG. 5 is another perspective view of the fastening part of the fastening device of the present invention;

FIG. 6 is a perspective view of the tightly-locking part of the fastening device of the present invention;

FIG. 7 is a perspective view of the fastening device of the present invention being assembled with the circuit board, the electronic card, and the connector; and

FIG. 8 is an exploded perspective view of the fastening device of the present invention being assembled with the circuit board, the electronic card, and the connector.

### DETAILED DESCRIPTION OF THE PREFERRED EMBODIMENTS

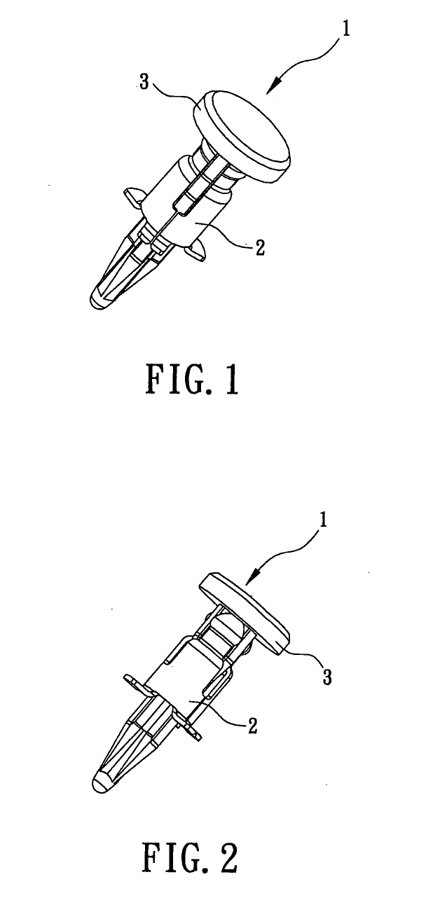

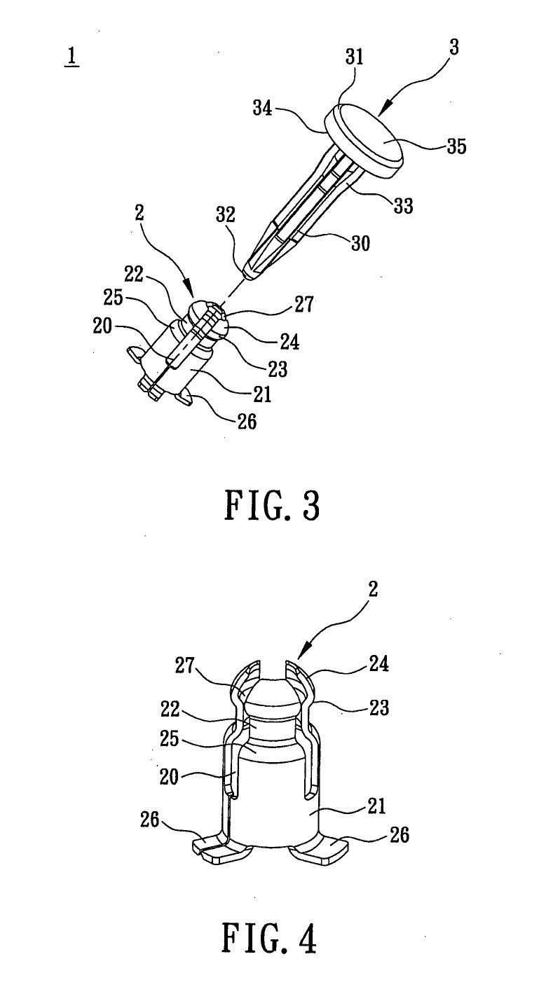

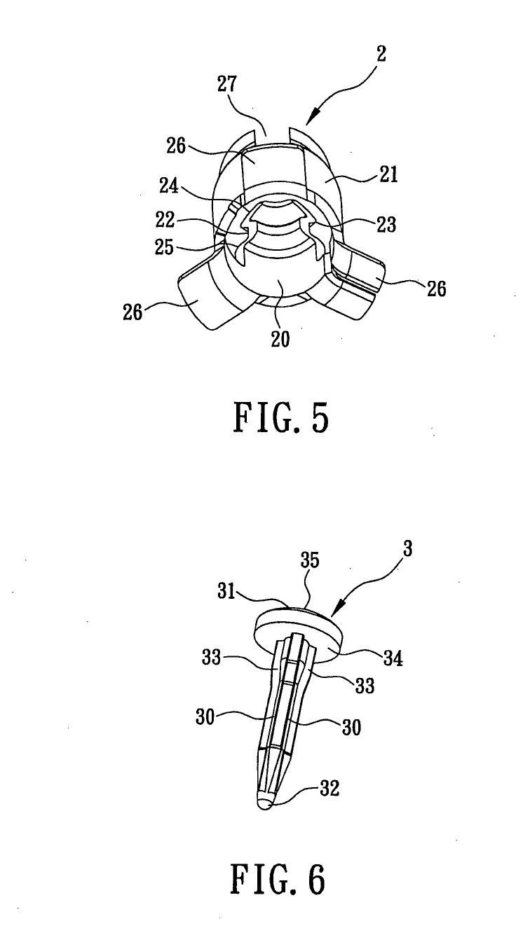

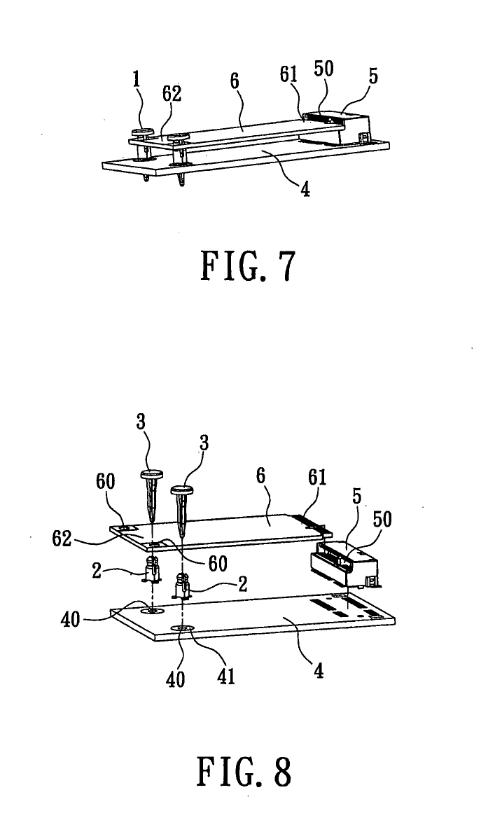

Reference is made to FIGS. 1˜8. The fastening device 1 is used for fastening a fastened object (in this embodiment, the fastened object is an electronic card 6, alternatively, it also can be another object, such as a circuit board) on a circuit board 4. The fastening device 1 includes a fastening part 2 for fastening the fastened object and a tightly-locking part 3 fitting with the fastening part 2.

The fastening part 2 is a flexible part that has a column shape. The fastening part 2 includes a main body portion 21. The main body portion 21 extends to form a wedging portion 22. An end of the wedging portion 22 extends to form a buckling portion 23. On end of the buckling portion 23 that is far away from the main body portion 21 extends to form a guiding portion 24 that can guide the fastened object into the buckling portion 23. The guiding portion 24 is convex upwards and has an arc shape. The buckling portion 23 is concave downwards and has an arc shape. A contacting and holding portion 25 is located between the main body portion 21 and the wedging portion 22 for contacting and pushing the fastened object. The contacting and holding portion 25 has an arc shape. Alternatively, the contacting and holding portion 25 can be laddered-shape. The bottom of the main body portion 21 of the fastening part 2 extends to form a welding portion 26. The bottom of the main body portion 21 bends outwards and extends to form the welding portion 26. The welding portion 26 has a flake shape, and is vertical to the main body portion 21. Alternatively, the welding portion 26 can be circular-disk shaped. The main body portion 21 of the fastening part 2 has a hollow structure 20. There is a flexible space 27 between the main body portion 21 and the guiding portion 24 that links with the hollow structure 20 of the main body portion 21.

The tightly-locking part 3 includes a pivoting portion 30 and a head portion 31 located above the pivoting portion 30. The end portion 32 of the pivoting portion 30 is semi-spherical. There is a positioning convex rib 33 on the pivoting portion 30 that fits with the flexible space 27 of the fastening part 2. The positioning convex rib 33 gradually narrows from top to bottom and extends and is close to the end portion 32. The head 31 includes a lower surface 34 and a flat upper surface 35 that can be absorbed. The side edge of the head portion 31 is smooth. Alternatively, the side edge of the head portion 31 can be sawtooth-shaped. The diameter of the head portion 31 is larger than the diameter of the pivoting portion 30 and the main body portion 21 of the fastening part 2. When the fastening device is operated, the lower surface 34 of the head portion 31 contacts the upper edge of the guiding portion 24 of the fastening part 2 to make the tightly-locking part 3 firmly fit with the fastening part 2.

The circuit board 4 has a first positioning hole 40 for positioning the fastening device 1, and a welding area 41 that is welded with the welding portion 26 of the fastening device 1.

In this embodiment, the electronic card 6 has a first end 61 and a second end 62. The second end 62 has a second positioning hole 60 The electrical connector 5 installed on the circuit board 4 has at least one plugging opening 50.

When the electronic card 6 is installed, at least one fastening device 1 is used for aligning the fastening part 2 of the fastening device 1 to the first positioning hole 40 on the circuit board 4. The welding portion 26 also aligns to the welding area 41 on the circuit board 4. The first end 61 of the electronic card 6 is plugged into the plugging opening 50 of the electrical connector 5 on the circuit board 4. The second positioning hole 60 on the second end 62 aligns to the fastening part 2. Because the fastening part 2 has the guiding portion 24, the buckling portion 23 and the flexible space 27, the guiding portion 24 and the buckling portion 23 is exerted by an inward force and moves to the inner side when the second end 62 of the electronic card 6 is pressed. At this time, the second end 62 of the electronic card 6 moves downwards along the outer wall of the guiding portion 24. When the upper surface of the second end 62 of the electronic card 6 passes through the connecting area of the guiding portion 24 and the buckling portion 23, The inner wall of the second positioning hole 60 of the second end 62 of the electronic card 6 slides downwards along the outer wall of the buckling portion 23 of the fastening part 2 due to a reacting force until the electronic card 6 is fully fastened on the wedging portion 22 of the fastening part 2. By cooperating the buckling portion 23, the wedging portion 22 with the guiding portion 24, and the electronic card 6 is firmly fastened. In order to make the electronic card 6 be more firmly fastened and being not easily escaping from the connector, the tightly-locking part 3 aligns to the flexible space 27 and the hollow structure 20 of the fastening part 2, and passes through the fastening part 2 and the first positioning hole 40 of the circuit board 4 until the lower surface 34 of the head 31 of the tightly-locking part 3 contacts the upper edge of the guiding portion 24 of the fastening part 2. At this time, one end of the tightly-locking part 3 passes through the main body portion 21 of the fastening part 2 and is positioned on the first positioning hole 40 of the circuit board 4. The upper end of the positioning convex rib 33 of the tightly-locking part 3 fits with the flexible space 27 of the fastening part 2, and the lower end of the positioning convex rib 33 tightly locks with the main body portion 21 of the fastening part 2 and the first positioning hole 40 of the circuit board 4. The second end of the tightly-locking part 3 fits with the buckling portion 23 to tightly lock the electronic card 6.

When the electronic card 6 is released, the tightly-locking part 3 is drawn out. Next, a force is exerted onto the guiding portion 24 and the buckling portion 23 to make the guiding portion 24 and the buckling portion 23 move forwards the inner side. Due the recovery force, the second end 62 of the electronic card 6 springs upwards from the fastening part 2.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. A fastening device, used for fastening a fastened object on a circuit board, comprising:
a fastening part for fastening the fastened object, wherein the fastening part includes a main body portion, the main body portion extends to form a wedging portion, and an end of the wedging portion extends to form a buckling portion; and
a tightly-locking part fitting with the fastening part, wherein one end of the tightly-locking part passes through the main body portion of the fastening part and is positioned on the positioning hole of the circuit board, and second end of the tightly-locking part fits with the buckling portion to tightly lock the fastened object.

2. The fastening device as claimed in claim 1, wherein a bottom of the main body portion of the fastening part extends to form a welding portion.

3. The fastening device as claimed in claim 2, wherein the bottom of the main body portion bends outwards and extends to form the welding portion.

4. The fastening device as claimed in claim 1, wherein one end of the buckling portion that is far away from the main body portion extends to form a guiding portion for guiding the fastened object into the buckling portion.

5. The fastening device as claimed in claim 1, wherein there is a contacting and holding portion between the main body portion and the wedging portion for contacting and pushing the fastened object.

6. The fastening device as claimed in claim 1, wherein the main body portion of the fastening part has a hollow structure.

7. The fastening device as claimed in claim 6, wherein one end of the buckling portion that is far away from the main body portion extends to form a guiding portion for guiding the fastened object into the buckling portion, and there is a flexible space between the main body portion and the guiding portion that links with the hollow structure of the main body portion.

8. The fastening device as claimed in claim 7, wherein the tightly-locking part includes a pivoting portion and a head portion located above the pivoting portion.

9. The fastening device as claimed in claim 8, wherein the head portion of the tightly-locking part has a flat surface that is absorbed.

10. The fastening device as claimed in claim 8, wherein the pivoting portion has a positioning convex rib that fits with the flexible space of the fastening part.
